(19) United States
(12) Patent Application Publication
(10) Pub. No.: US 2012/0210828 A1
(43) Pub. Date: Aug. 23, 2012

(54) Make/Break Tool

(76) Inventor: Daniel S. Bangert, Broussard, LA (US)

(21) Appl. No.: 13/402,541

(22) Filed: Feb. 22, 2012

Related U.S. Application Data
(60) Provisional application No. 61/445,888, filed on Feb. 23, 2011.

(51) Int. Cl. E21B 19/16; B25B 13/50

(52) U.S. Cl. 81/57.34; 81/57.33

(57) ABSTRACT

A make/break tool having (a) a base plate and (b) a swivel housing rotatively mounted on the base plate. The swivel housing includes (i) a center aperture; (ii) at least one gripping linear actuator; and (iii) at least one a lever arm. The tool further includes a torque linear actuator having (i) an actuator rod and an actuator body, where at least one actuator rod end is pivotally connected relative to the base plate; and (ii) a pivotal connection to a distal end of the lever arm.

This application claims the benefit of U.S. Patent Application No. 61/445,888, filed on Feb. 23, 2011, which is incorporated by reference herein in its entirety.

### I. BACKGROUND OF INVENTION

Make/Break tools (“M/B tools”) are devices for applying high torque to the threaded joints of casing, drill pipe, and other tubular members, particularly as used in the petroleum industry. M/B tools typically do not rotate continuously. Instead they work in a ratcheting fashion so a number of cycles are required to make a complete 360 degree rotation of a threaded pipe joint connection. M/B tools are often used on threaded connections which are free-running until they are shouldered. Connections of this type are typical in rotary shouldered drill pipe or straight threads used in downhole tools. These connections will usually be made up by hand or with a spinner wrench until they are shouldered and then a M/B tool will generate the torque needed to fully makeup the connection. M/B tools are also be used to breakout these connections. M/B tools are usually employed as two major components, frequently called “heads”. One head rotates relative to a frame and is normally referred to as the “tong” or “headstock” section. The second head is fixed relative to a frame and is normally referred to as the “backup” or “tailstock” section. As used herein, “M/B tool” may refer to the tong and backup sections used together or, in more specialized applications, when the tong section is used alone or in conjunction with a device not considered a backup section.

### II. BRIEF DESCRIPTION OF THE DRAWINGS

FIG. 1 illustrates one embodiment of the make/break tool together with a backup tong.

FIG. 2 illustrates the tool of FIG. 1 with the top plate removed.

FIG. 3 illustrates the tool of FIG. 1 with the upper swivel housing plate removed.

FIG. 4 illustrates the rotation of the swivel housing in the clockwise direction.

FIG. 5 an alternate embodiment having the double rod cylinder pinned at both ends.

FIG. 6 illustrates one embodiment of a bearing assembly forming the ring hub.

FIG. 7 illustrates a sectional view of a leg tube.

FIG. 8 illustrates one embodiment of the tool with an extended connector tube.

FIG. 9 illustrates the tool of FIG. 1 used in conjunction with a larger torque applying device.

FIG. 10 illustrates a force diagram suggesting constant torque applied to the tubular.

### III. DETAILED DESCRIPTION OF SELECTED EMBODIMENTS

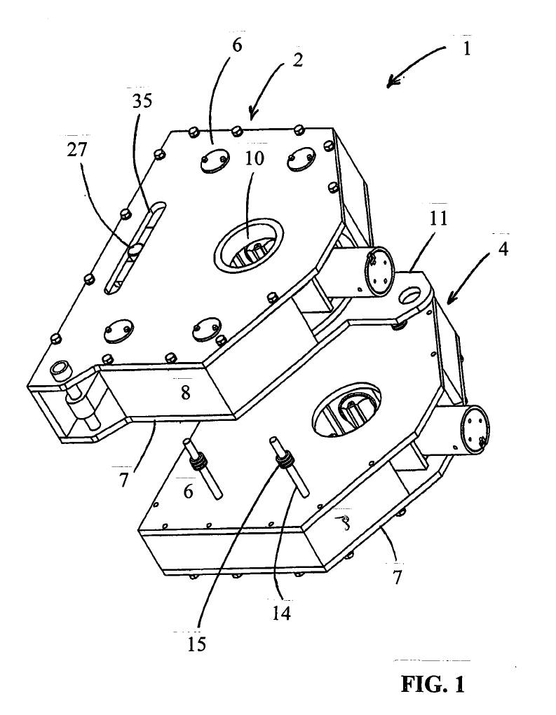

One embodiment of the make/break tool (or “M/B tool”) is shown in FIGS. 1-4. The M/B tool 1 will generally consist of the tong section 2 seen in FIG. 1. Although the M/B tool 1 will often be used in conjunction with a back-up section 4 or another tool for holding a lower tubular against rotation, the current invention also includes a M/B tool consisting of the tong section 2 alone. In one nonlimiting example, back-up section 4 is a backup tong such as disclosed in U.S. Pat. No. 4,649,777 to David Buck, which is incorporated by reference herein.

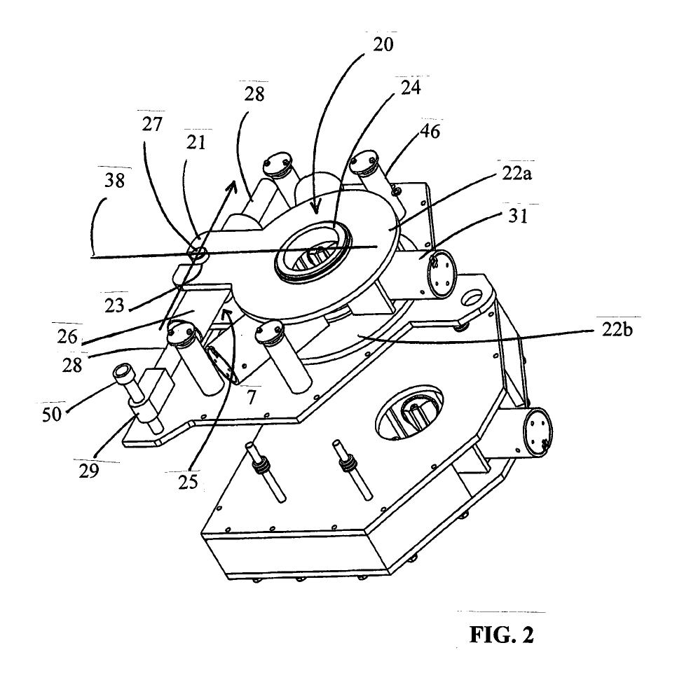

The M/B tool 1 in FIG. 1 shows a housing including top plate 6, base plate 7, and side plates 8. Both top plate 8 and base plate 7 have trunnion guide slots 35 and center passages or apertures 10 (through which tubulars may pass). In many embodiments, the diameter of aperture 10 will be large enough to accommodate typical oil field tubular diameter ranging between about 3.5 and about 24 inches. However, aperture 10 could be larger or smaller in more specialized embodiments. FIG. 2 illustrates M/B tool 1 with the top plate 6 and side plates 8 removed. This view shows the swivel housing 20 rotatively mounted on base plate 7. This embodiment of swivel housing 20 includes the upper swivel plate 22a and lower swivel plate 22b. Both swivel plates have a center aperture 24 and a lever arm 21 which includes a trunnion aperture (or slot or notch) 23 formed on the end of lever arm 21 opposite center aperture 24. In the illustrated embodiment, trunnion aperture 23 is shown as elongated and open ended, but other embodiments could have a closed-end trunnion aperture 23 and the aperture could take on other general shapes. FIG. 2 illustrates how this embodiment provides a trunnion aperture which is elongated in the direction of a long axis 38 of lever arm 21.

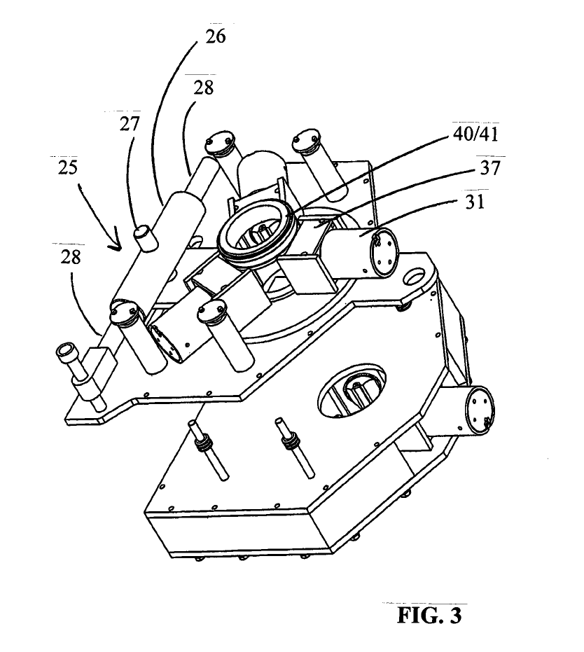

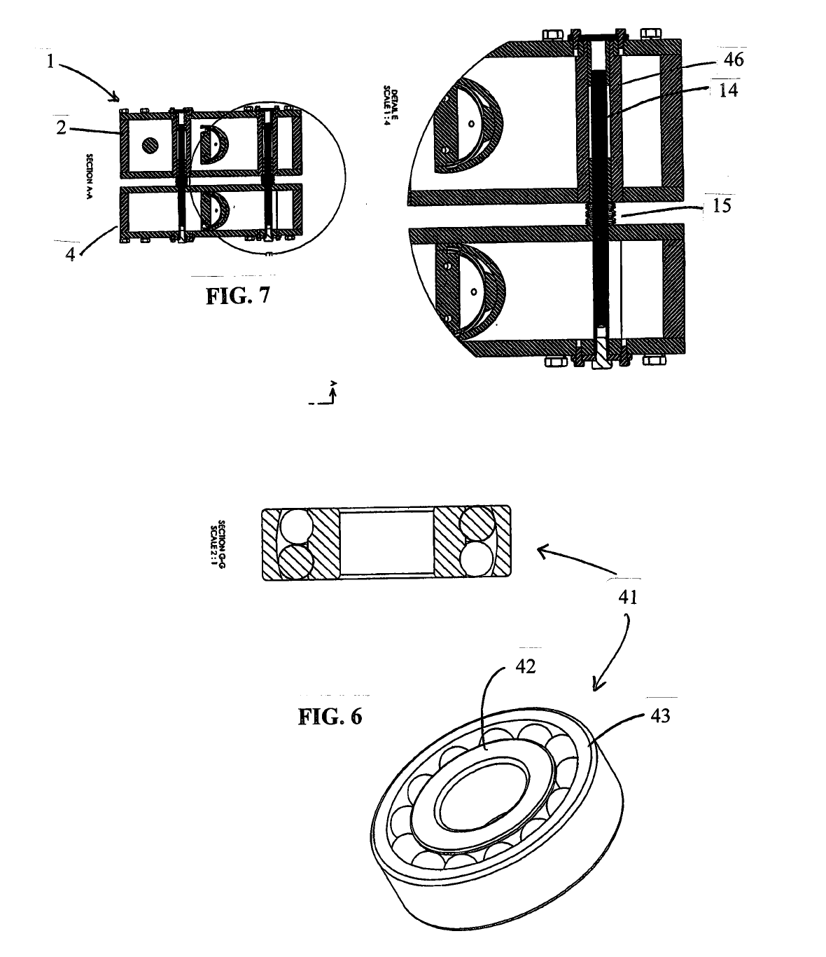

FIG. 3 shows the upper swivel housing plate 22a removed to reveal the components internal to swivel housing 20. These include the upper ring hub 40 (and a lower ring hub largely hidden from view) and the gripping cylinder assemblies 31. In the embodiment shown, ring hubs 40 are cylindrical roller bearing assemblies 41 (see FIG. 6) with an inner race 42 secured (e.g., press fit) to the circumference of swivel plate center apertures 24 and the outer race 43 engaging the apertures in the top and base plates 6 and 7. It will be understood that this arrangement allows swivel housing 20 to rotate relative to the overall M/B tool housing, i.e., relative to top and base plates 6 and 7. Alternatively, ring hub 40 could take the form of virtually any other conventional or future developed bearing surface allowing comparatively low friction rotation of swivel housing 20 with respect to top and base plates 6 and 7, including as nonlimiting examples a simple brass sleeve or a teflon ring positioned between the swivel housing and the top/base plates. Many alternative materials or coatings could likewise be employed to reduce friction. Non-limiting examples could include Xylan, Ultra High Molecular Weight Polyethylene (UHMW), Nedox coatings, or various techniques to increase surface hardness and reduce friction, one example of which is Salt Bath Nitriding aka Quench Polish Quench (QPQ) techniques.

The FIG. 3 embodiment shows three gripping cylinder assemblies 31 secured into place between swivel housing plates 22a /22b by the cylinder mounting blocks 37. It will be understood that with swivel housing plates 22a/22b fixed to cylinder mounting blocks 37 (e.g., by welding), the housing plates, mounting blocks, and gripping cylinder assemblies 31 rotate as a single unit and thereby apply torque to any tubular member engaged by gripping cylinder assemblies 31. While FIG. 3 illustrates three gripping cylinder assemblies 31, it will be understood that alternate embodiments could employ two gripping cylinder assemblies or more than three cylinder assemblies (e.g., four, five, six or more). As a further alternative, certain embodiments might employ a single gripping cylinder assembly 31 which is then opposed by one, two, three, or more fixed jaw members. In other words, a tubular would be gripped by the single gripping cylinder assembly pushing the tubular against jaw members that are fixed in place around the circumference of the swivel plate center aperture 24. Centering of the tool joint can also be accomplished when fixed jaws are used if the cylinders are dressed with wraparound dies or v-block style jaws with strip dies sized to match the tubular or tool joint OD.

In one preferred embodiment, the gripping cylinder assemblies 31 are “long stroke” cylinder assemblies, for example having a stroke length (the distance the piston moves between the fully extended and fully retracted position) of between about 4 inches and about 10 inches. Likewise, preferred gripping cylinder assemblies 31 will have a piston face diameter ranging from about 5 inches to about 9 inches. These long stroke gripping cylinders can be dressed with a variety of jaws having differing die configurations with the most common being a single dovetail style die insert. Typically long stroke cylinders are used in sets of three to six cylinders uniformly spaced out around the tool joint. Their movement may controlled and synchronized using flow dividers to centralize and grip the tubing.

FIGS. 2 and 3 also illustrate how a torque cylinder 25 engages lever arms 21 of swivel housing 20 in order to generate torque on a tubular being gripped within swivel housing 20. The illustrated torque cylinder 25 is a double rod piston and cylinder assembly formed of the cylinder body 26 and two piston rods 28. Double rod cylinders possess the advantage that the same piston surface area is exposed to hydraulic fluid during the extension and retraction phases; thus providing more uniform force during extension and retraction of the rods. Cylinder body 26 will further include a pair of trunnions 27 extending therefrom. It may be seen in FIG. 2 how the cylinder trunnions 27 engage the trunnion apertures 23 on lever arms 21 where trunnions 27 are free to pivot within apertures 23. In certain embodiments, a bearing surface could be positioned between trunnions 27 and apertures 23; for example a plain bearing (e.g., a sleeve) around trunnion 27 or a rolling element bearing (e.g., ball bearing) on trunnion 27. However, other embodiments may simply operate with the metal to metal surfaces of the trunnions and trunnion apertures directly engaging one another. The trunnion and trunnion aperture is only one particular means of forming the rotative connection between the torque cylinder and the lever arm and any other existing or future developed rotating connection could be employed in the alternative.

FIG. 2 also shows one of the double piston rods 28 further including a pin aperture 29 positioned on one end and a pin 50 engaging pin aperture 29. It will be understood that pin 50 engages top and base plates 6 and 7 to form a pivoting connection allowing pin aperture 29 (and torque cylinder 25) to pivot relative to the M/B tool housing. In one embodiment, pin 50 will be a load cell pin such as the force sensing pins manufactured by Strainsert Company of West Conshohocken, Pa., thereby allowing direct measurement of force exerted on lever arm 24 by torque cylinder 25.

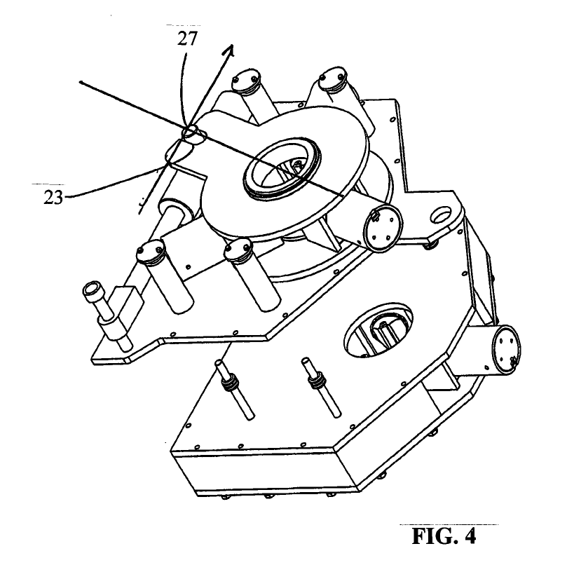

As best seen in FIG. 1, one embodiment of the M/B tool contemplates trunnion 27 engaging the elongated slots 35 in top plate 6 and base plate 7, thereby constraining torque cylinder 25 to a single axis of movement when cylinder rods 28 are extended or retracted. Viewing FIG. 4, it will be apparent that extending and retracting the cylinder rods 28 causes trunnions 27 to move lever arm 24 and impart torque to swivel housing 20 in the clockwise or counter-clockwise direction. The elongated shape of trunnion apertures 23 allow trunnions 27 to shift position slightly in apertures 23 as lever arm 24 travels in a circular path and trunnions 27 are constrained to a linear path.

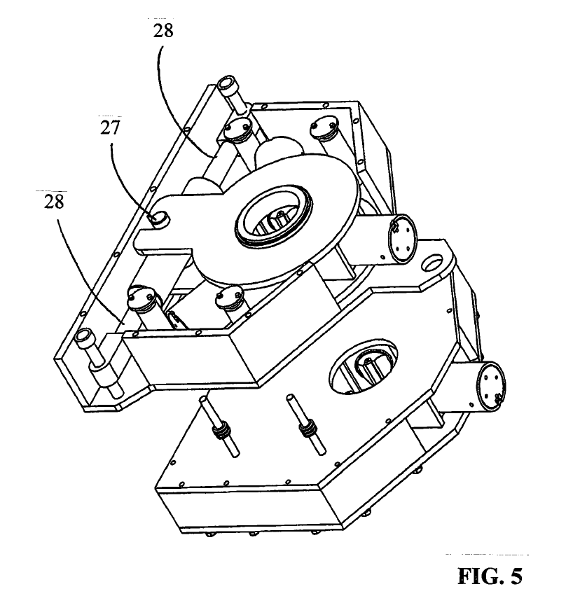

FIG. 5 illustrates a modification to the embodiments described above. In the FIG. 5 embodiment, the ends of both cylinder rods 28 are pinned to top and base plates 6 and 7. This structure operates to constrain the torque cylinder to a single axis of linear movement without the necessity of trunnions 27 engaging the guide slots 35.

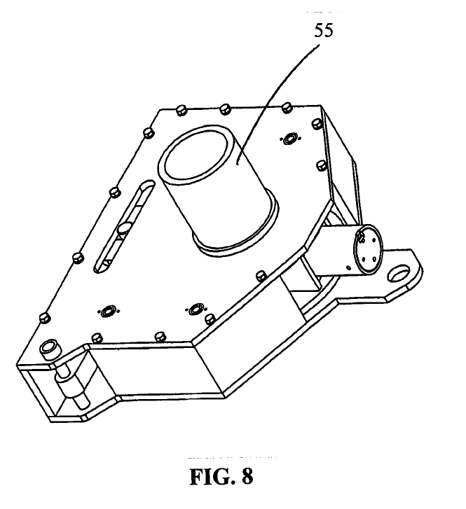

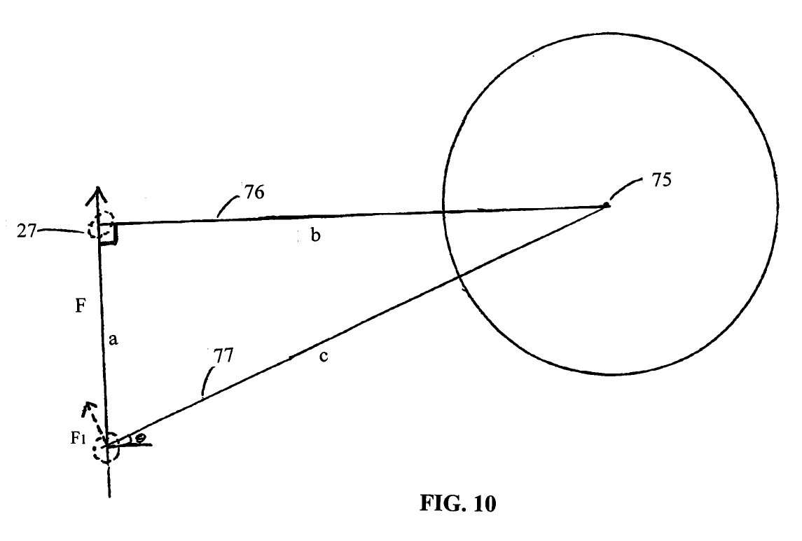

As suggested in FIG. 10, the torque applied to a tubular by the M/B tool is the product of force applied to the lever arm (force vector “F” in FIG. 10) multiplied by the distance 76 between the trunnion and the center point 75 of the swivel housings center aperture 24. As described above, the direction of force applied to the lever arm will remain constant because trunnion 27 is constrained to movement within slots 35 in the top and base plates. However, the distance will vary slightly depending on the position of trunnion 27 along slot 35. For example, a slightly longer distance 77 exists when trunnion 27 is in the lower position shown in FIG. 10. However, the torque applied at center point 75 remains constant regardless of the position of trunnion 27. Even though the distance 77 has increased in the trunnion's lower position, the force perpendicular to distance 77 (F₁ in FIG. 10) operates such that the torque remains constant at all positions of trunnion 27 in slot 35. In embodiments which are combined with a backup section 4 (as seen in FIG. 1), the connection between the tong section 2 and the backup section 4 may be formed by a series of support legs 14 extending between the tong section 2 and the backup section 4. As seen in FIG. 7, support leg tubes 46 are formed in the body of tong section 2 to receive and secure support legs 14 within tong section 2. FIG. 7 also illustrates the support leg 14 fixed to the bottom plate of backup section 4 and sliding freely within the leg tube 46 in tong section 2. Typically, support legs 14 will include a compensating spring 15 allowing the tong section 2 to “float” on backup section 4 and allow a slight increase or decrease of distance between tong section 2 and backup section 4 as a threaded joints are made-up or broken out.

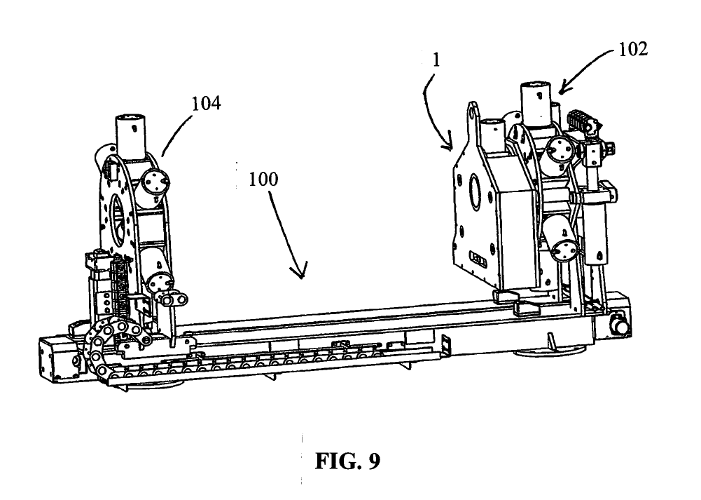

An alternate embodiment of the M/B tool is illustrated in FIG. 8. In this embodiment, an extension tube 55 is welded to the inner race of ring hub 40 (or to top plate 6) such that extension tube 55 is securely fixed to the M/B tool body in a non-rotating manner. As suggested in FIG. 9, the extension tube 55 may be gripped and rigidly held by a larger pipe gripping apparatus (e.g., a larger M/B tool/system 100), for example, a model RP 3000 available from McCoy Corporation of Edmonton, Calif. as shown FIG. 9. Larger M/B systems designed for larger diameter tubulars and to apply higher torque loads may not be able to grip smaller diameter tubulars or accurately apply lower level torque loads. In order to allow such larger M/B systems to effectively handle smaller diameter tubulars, FIG. 9 suggests how M/B tool 1 may be combined with the larger M/B system 100. In FIG. 9, the extension tube 55 is being gripped by the larger tool's tong section 102. The tubular or other work piece would then be inserted and gripped by M/B tool 1 while the other end of the work piece is gripped by the larger tool's backup section 104. The smaller M/B tool 1 with reduced friction bearings has lower breakaway friction and higher efficiency, allowing more precise control of the applied loads. The smaller M/B tool 1 may also use smaller, range appropriate sensors, which provide much greater absolute accuracy when measuring smaller forces than can normally be obtained with sensors utilized in larger tools.

Although the present invention has been described in terms of specific embodiments, those skilled in the art will recognize many variations and modifications. For example, while not explicitly shown in the drawings, one alternative embodiment replaces a the single double rod cylinder with two single rod cylinders. The rod arms on each cylinder could pivotally engage the lever arm of the swivel housing plates. As another alternative example, where the above embodiments disclose the use of hydraulic cylinders, alternative embodiment could utilize any type of conventional or future developed linear actuator (e.g., pneumatic cylinders, electric power screws, etc.).

Another alternative make/break tool comprises (a) a base plate; and (b) a swivel housing rotatively mounted on the base plate. The swivel housing comprises: (i) a center aperture; (ii) at least one gripping linear actuator; and (iii) at least one a lever arm. The tool further includes a torque linear actuator comprising: (i) an actuator rod and an actuator body, where at least one actuator rod end is pivotally connected relative to the base plate; and (ii) a pivotal connection to a distal end of the lever arm. In one modifications of this tool, the torque linear actuator is constrained to a linear axis of movement.

All such variations and modifications are intended to fall within the scope of the following claims.

1. A make/break tool comprising:
a. a base plate;
b. a swivel housing rotatively mounted on the base plate, the swivel housing comprising:
i) upper and lower housing plates with a center aperture formed therethough;
ii) at least three gripping cylinder assemblies;
iii) a lever arm extending from at least one of the housing plates and including a trunnion aperture distal from the center aperture;
c) a double rod torque cylinder comprising:
i) at least one rod end pivotally connected relative to the base plate;
ii) a trunnion engaging the trunnion aperture on the lever arm.

2. The make/break tool according to claim 1, further comprising a top plate including an elongated slot engaged by the trunnion of the torque cylinder.

3. The make/break tool according to claim 1, wherein the trunnion aperture is elongated in the direction of a long axis of the lever arm.

4. The make/break tool according to claim 3, wherein the trunnion aperture is open-ended.

5. The make/break tool according to claim 1, wherein a ring hub rotatively connects the swivel housing to the base plate.

6. The make/break tool according to claim 5, wherein the ring hub comprises either a cylindrical roller bearing or a low friction sleeve, sleeve segments, or a plurality of cam followers.

7. The make/break tool according to claim 6, wherein the low friction sleeve comprises brass, teflon, or a similar friction reducing material or coating.

8. The make/break tool according to claim 1, wherein the gripping cylinder assemblies comprise long stroke cylinder assemblies having a stroke length of between about 4 inches and about 10 inches.

9. The make/break tool according to claim 1, wherein the double rod cylinder is constrained to a single axis of movement.

10. The make/break tool according to claim 9, wherein the double rod cylinder is constrained by the trunnion engaging an elongated slot formed in a top plate and in the base plate.

11. The make/break tool according to claim 1, wherein the cylinder assemblies have a piston face diameter ranging from about 3 inches to about 8 inches.

12. The make/break tool according to claim 1, wherein a low friction surface is positioned between the cylinder trunnion and the trunnion aperture.

13. The make/break tool according to claim 9, wherein both rod ends of the double rod cylinder are pinned.

14. The make/break tool according to claim 1, wherein a backup tong is connected to the make/break tool by a plurality of leg members.

15. The make/break tool according to claim 14, wherein the leg members comprise compensating springs.

16. The make/break tool according to claim 1, wherein a second rod end of the double rod cylinder is connected relative to the base plate.

17. The make/break tool according to claim 1, wherein an extension tube having an inner diameter approximate to the center aperture is fixed relative to the base plate.

18. The make/break tool according to claim 1, wherein a lever arm is integrally formed with each of the housing plates.

19. The make/break tool according to claim 1, wherein the rod end is directly pinned to the base plate by a load cell pin.

20. A make/break tool comprising:
a. a base plate;
b. a swivel housing rotatively mounted on the base plate, the swivel housing comprising:
i) a center aperture;
ii) at least one gripping cylinder assembly;
iii) at least one a lever arm;
c. a torque cylinder comprising:
i) at least one rod end pivotally connected relative to the base plate;
ii) a pivotal connection to a distal end of the lever arm;
d. wherein the torque cylinder is constrained to a linear axis of movement.

21. The make/break tool according to claim 20, wherein the torque cylinder is constrained to a single axis of movement.

22. The make/break tool according to claim 20, wherein the torque cylinder includes a trunnion pivotally engaging the lever arm.

23. The make/break tool according to claim 20, wherein the swivel housing comprises upper and lower swivel housing plates.

24. The make/break tool according to claim 23, wherein the lever arm is integrally formed on the swivel housing plates.

25. The make/break tool according to claim 20, wherein the torque cylinder is a double rod cylinder.

26. The make/break tool according to claim 20, wherein said swivel housing comprises a plurality of gripping cylinder assemblies.

27. A make/break tool comprising:
a. a base plate;
b. a swivel housing rotatively mounted on the base plate, the swivel housing comprising:
i) a center aperture;
ii) at least one gripping linear actuator;
iii) at least one a lever arm;
c. a torque linear actuator comprising:
i) an actuator rod and an actuator body, at least one actuator rod end pivotally connected relative to the base plate;
ii) a pivotal connection to a distal end of the lever arm;
d. wherein the torque linear actuator is constrained to a linear axis of movement.

28. A combination make/break system comprising:
a. first make/break tool having a first torque application range;
b. a second make/break tool have a second and lower torque application range, the second make/break tool further including:
(i) a body;
(ii) a swivel housing rotatively mounted on the body, the swivel housing including a center aperture, at least one gripping linear actuator, and at least one lever arm;
(iii) a torque linear actuator including an actuator rod and an actuator body, at least one actuator rod end pivotally connected relative to the body, and a pivotal connection to a distal end of the lever arm; and
(iv) an extension tube attached to and extending from the body;
c. wherein the extension tube of the second make/break tool is gripped by the first make/break tool, thereby allowing application, to a tubular being gripped, of a lower and/or more precise torque range than the first make/break tool can apply.
